(19) United States
(12) Patent Application Publication
(10) Pub. No.: US 2006/0294039 A1
(43) Pub. Date: Dec. 28, 2006

(54) File migration history controls updating or pointers

(76) Inventors: Gerhardus Engbertus Mekenkamp, Eindhoven (NL); Igor Wilhelmus Franciscus Paulussen, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/569,018

(22) PCT Filed: Aug. 6, 2004
(86) PCT No.: PCT/IB04/51414

§ 371 Date: Feb. 23, 2006

(30) Foreign Application Priority Data
Aug. 29, 2003 (EP) 03103245.1

(51) Int. Cl. G06F 17/30

(52) U.S. Cl. 707/1

(57) ABSTRACT

On a distributed data processing system, a history of file migration is maintained. When access to a file is requested and the file is not found, the migration history is consulted to determine the current location of the file, and to update links contained in other files that point to the request file.

### FIELD OF THE INVENTION

The invention relates to a method of enabling access to a specific file on a data processing system. The file comprises, e.g., an electronic document stored on a home network or a Web page on the Internet, or a software application.

### BACKGROUND ART

On a distributed data processing system files can be moved between the system's storage devices, for example, for manually re-organizing files or as a result of an automated caching procedure. As to the latter see, e.g., published International Application WO 0113265 (attorney docket PHA 23,737) filed for Chanda Dharap for SEMANTIC CACHING. Migration of files throughout the system or re-naming files lead to a change of the physical and/or logical addresses of the files. Without adequate measures this may hamper accessibility of a migrated or renamed file, as the old address has been rendered inoperable.

For example, U.S. Pat. No. 5,333,315 discloses a computer file system, having a multiplicity of distinct disk storage devices with a multiplicity of file directories, stored on various disks. Each file directory is used to translate file names into corresponding tag values. For each disk there is a file descriptor table with a file descriptor entry for every file stored on the disk. A single tag directory contains one tag entry for every file stored in the system. The tag directory is used by the file system to find a file by translating a tag value into a pointer to the disk on which the file is stored and a pointer to the file's file descriptor entry. To move a file from a first disk to a second disk, the file is copied to the second disk, a new file descriptor entry for the copied file is generated in the file descriptor table for the second disk, the copy of the file on the first disk is de-allocated, and the tag entry for the file is updated to point to the second disk and to the file's new file descriptor entry. Thus, a file can be moved from a first disk a second without having to locate and update all the corresponding file directory entries. As another example, U.S. Pat. No. 5,564,037 discloses a system and method for real time data migration in a networked computer system that uses a sparse file to represent a migrated file. The sparse file consumes a minimum amount of physical space on the file server but is defined as having the same size and attributes as the original final. When a user accesses a migrated file, the file appears to be resident on the file server and is automatically and transparently returned to the file server from an optimized storage location in a hierarchical storage management system.

In Linux and Windows operating systems it is possible to add links, or “shortcuts” in Windows' terminology, to a file system. Alternatively, a link is a pointer comprised in a file, e.g., an electronic document or software application, and pointing to another document or to another software application at a certain storage location. A location can be on any storage device or in any file system. A link is typically represented by an interactive element in a graphical user-interface (GUI) representative of a pointer to a file or to an application. The link, when activated, executes the command to open the associated file or to start the associated application. Links allow conveniently organizing, interlinking and quickly finding specific files or directories.

When a file is moved to another location, the links that point to it are rendered inoperable. Some commercially available software packages include tools to find the new location of the file by searching the full file-system structure. For example, the Windows NT operating system has a Windows Explorer that lets the user navigate through a hierarchically organized file structure. Windows Explorer also provides a “Find” tool in order to find a file or a directory if the user knows the name of the file or of the directory, or if the user knows a string of text occurring in the file.

In a distributed system or network the problem of retrieving files that have been moved becomes even harder. A link can point to a location on a device and in this case the link is to identify the device, e.g., by including the device's name or network address. Uniform resource locators (URLs), the Internet-equivalent of network addresses, are an example of such links. When a file is moved or copied, links that need to be updated could be present on many access devices throughout the network. Even if a mechanism were implemented on the network to modify these links, the mechanism would not work for an access device that contains a link and has been turned off. When the device is turned on again its links might need to be modified.

### SUMMARY OF THE INVENTION

The inventors propose a method of enabling access to a specific file on a data processing system. A history is maintained of the specific file regarding migration of the specific file on the system. Upon access of a specific link representative of a pointer to a particular location associated with the specific file in a time period covered by the history, a current location of the specific file is determined based on the history. Preferably, the history is consulted after the initial access of the link has resulted in the specific file not being found. If the specific link can be modified it can be updated, preferably upon the access of the specific link. The invention enables, among other things, to access a file from a device via a pre-determined link stored at the device if the file has moved to a new location.

In an embodiment of the invention, the method comprises maintaining a list of respective further files comprising respective links to the specific file. The list is preferably maintained at the device originally storing the specific file, i.e., the device to be addressed according to the original link in order to access the specific file. The specific file may have moved to another location at the same device or at another device. The list includes information about the current location of the specific file, and identifiers of the further files that have pointers to the specific file. Alternatively, only the current location of the specific file and the number of links pointing to this specific file are kept in the list.

If the respective links are updated to be representative of the current location, this is preferably carried out upon access of the specific link. When a new link is created pointing to this specific file, an indication of this new link is added to this list. When the file is moved to another location, the list comprises the indications of all links that need to be redirected to the new location. If a link points to a storage location on a network, an additional administration is maintained. Each file movement action is stored in case devices or applications are turned off or are inactive. When a device is turned on later or an application containing a link is started, the list of file movements that were performed during the period wherein the device or application was off can be inspected to determine if the device's links or application's links are to be updated. A problem with this approach is that links on ROM devices cannot be changed. Therefore, a link is preferably not updated when the file is moved, but when the associated link is accessed. This is accomplished, for example, as follows. Each device or application, or a dedicated network device or application, can maintain a movement history. The moving of a file will be recorded in the movement history. When a moved file's link is accessed, the movement history is inspected to reveal the current location of the content. The link itself can be left unchanged (needed for a ROM-device). In this case the movement history will continue to grow with each file movement. When the new location is found, the link can be updated. When all links have been updated, the movement action is preferably removed from the movement history. This then ensures that the movement history does not become too large when the system has been used for a long time.

An advantage of adapting links only when they are accessed is that the delay in the response time is small as not all links are accessed at the same time. Updating all links in a single sweep can stall the system for some time.

The invention can be implemented on, e.g., a home network, or on a corporate data network where multiple users have access and modify privileges regarding a document library. A first user can still retrieve a file moved throughout the network by a second user even if the old link is being used. The invention thus renders an obsolete link operable to maintain consistency of interlinked files. Furthermore, the invention can also be integrated with services of an Internet Service Provider (ISP) who provides access to the Internet, typically via a portal. A user typically bookmarks links to Web sites he/she has found to be interesting. If the party who governs a site changes the link, i.e., moves the corresponding file, the site's content cannot be retrieved anymore through the old link. The party may notify the ISP of the change or otherwise post the change so as to enable the ISP or itself or another party to maintain a file movement history as explained above. If a user accesses the old link, the request can automatically be re-directed request to the new address via the movement history, by default or as a special service. Alternatively, the ISP can automatically retrieve a cached version of the page at the old link, preferably notifying the user that the link has become obsolete and that the content has moved to a new address or has been replaced by updated content, etc. Accordingly, old bookmarks are maintained operable via a mapping to the up-to-date pointer using the migration history.

The movement history is, e.g., a lookup table of “from” (departure location) and “to” (destination location) file locations. The movement history is implemented, e.g., as a centralized service in a distributed system or is distributed among several components or devices. A distributed solution is easy to implement and does not have the problem of a single point of failure.

When a link that points to a certain storage location on a certain device is accessed, the movement history of the device can be inspected. If the file is present in the movement history the new location will be used.

In an embodiment of the invention, it is convenient to keep track of how many links point to a certain file and location if links are updated. If the number of links pointing to this file location becomes zero, the movement entry is removed from the movement history list. This prevents the movement history from growing in an unrestricted manner over time. When a file is moved multiple times, this counter can be used to remove intermediate moves if they have become obsolete.

In an embodiment of the invention, file movement information is stored at the histories maintained at both a source device, i.e., the device from which a file was moved, and a target device, i.e., the device toward which a file was moved. This provides the convenience of finding files by scanning all active devices in case the source device is turned off.

In a UPnP based system, a content directory service (CDS) is used to provide a view of a storage location. UPnP has standardized how search and browse actions are performed. The movement history is then implemented, e.g., by integrating it in the CDS implementation. More specifically, the CDS makes use of URI pointers and looks up content via a web service. The web service can contain an object that performs a mapping onto the new location using the movement history.

Additionally, in a system where all content is accessed via links (such as the UPnP CDS), content can be moved in the network without the problem that links point to no content anymore. When the system needs to move files, e.g., for load balancing (the system can automatically move content to other devices when one disk is nearly full) the links that point to these files can still be used, even if the actual content is moved. In this way content can be moved in the network while the user does not need to notice any of this and still can consistently access every file even when it is accessed through one or more links. The same is valid when it is a user initiated move.

An instantiation of the invention relates to control software for use on a data processing system. The software enabling access to a specific file on a data processing system, the software being operative to maintain a history regarding migration of the specific file on the system; and to determine a current location of the specific file based on the history upon access of a specific link representative of a pointer to a particular location associated with the specific file in a time period covered by the history. This control software is preferably installed on a distributed data processing system to make possible the functionalities discussed above.

### BRIEF DESCRIPTION OF THE DRAWING

The invention is explained in further detail, by way of example and with reference to the accompanying drawing wherein:

FIG. 1 is a block diagram of a system in the invention; and

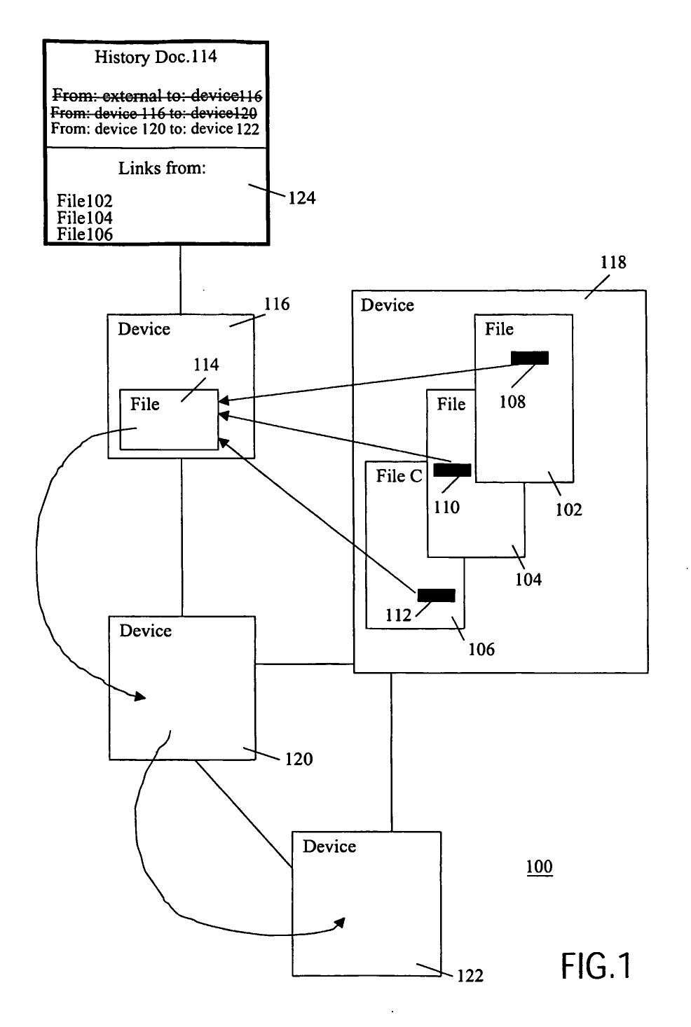

FIG. 2 is a flow diagram of a method in the invention.

Throughout the figures, same reference numerals indicate similar or corresponding features.

### DETAILED EMBODIMENTS

FIG. I is a diagram of a distributed data processing system 100 in the invention. System 100 has electronic files 102, 104 and 106, each of which has a link 108, 110 and 112, respectively, that is representative of a pointer to an electronic file 114 initially stored at an electronic device 116. Two or more of files 102-106 may reside at different devices or at the same device 118 as in this example. Activating any of links 108-112 from the relevant one of files 102-106 results in accessing file 114. Over time, file 114 migrates throughout system 100 and is moved from device 116 to a device 120, and from device 120 to a device 122. As explained above, moving a file, here file 114, may render a link, here links 108-112, representative of a pointer to the file, inoperable. System 100 ensures access to file 114 after its being moved. To this end, system 100 maintains a history 124 containing information regarding migration of file 114 on system 100. By way of history 124, system 100 is capable of determining a current location of a file, such as file 114, upon access of a corresponding link, here any of links 108-112. History 124 can be maintained at device 116 and/or at device 118, for example.

History 124 comprises information about the location of file 114. For example, history 124 comprises information on the most recent move of file 114 and the time instance at which the most current move occurred. If access of file 114 via, e.g., link 108 results in “file not found”, system 100 consults the most recent entry in history 124 to determine that file 114 resides at device 122 and under which pointer. In addition, history 124 comprises information about which files link to file 114, in this example files 102-106. System 100 preferably updates the pointer associated with link 108 when link 108 is accessed and is found to be inoperable initially. Consulting history 124 reveals that files 104-106 also have links to file 114. In an embodiment of the invention, the pointers associated with links 110-112 are then updated as well, as they all point to the same file 114. If file 102 is a read-only file, link 108 cannot be updated in the file, and redirecting the access request to file 114 via link 108 is to be achieved through history 124.

Note that, e.g., file 102 at device 118 can be a file system instead of a single file. Links can then also be present in the file system.

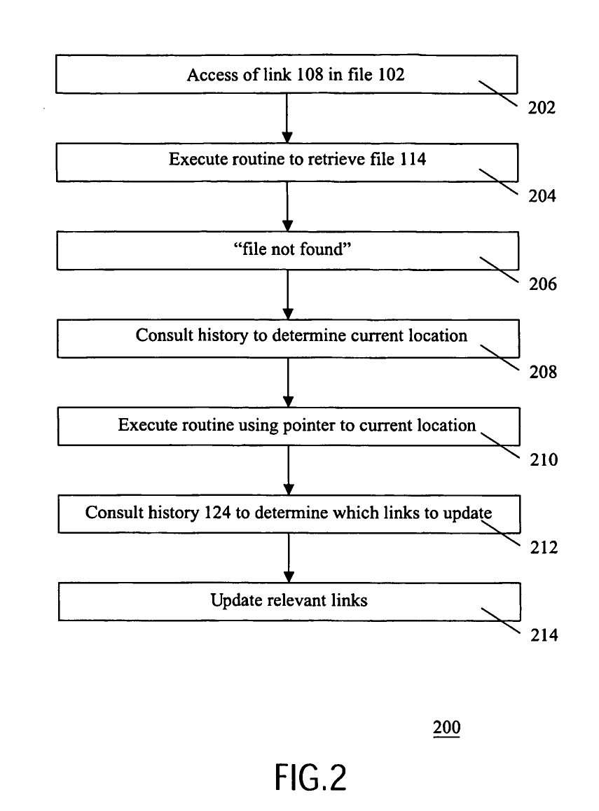

FIG. 2 is a flow diagram 200 with steps illustrating the method of the invention. In a step 202, link 108 is accessed from file 108. In a step 204, the routine corresponding with link 108 is carried out to retrieve or open file 114. As file 114 has moved, link 108 is inoperable and in a step 206, the routine returns a message that file 114 was not found. Step 206 is optional. System 100 intercepts this message and consults thereupon history 124 in a step 208 to find the current location of file 114. If the current location is found, the routine is executed again in a step 210, now using the new information about the current location of file 114. In a step 212, system 100 consults history 124 in order to determine whether there are more links pointing to file 114. If there are, and if these are updateable at device 118, system 100 initiates the updating process.

1. A method of enabling access to a specific file on a data processing system, the method comprising:
maintaining a history regarding migration of the specific file on the system; and
upon access of a specific link representative of a pointer to a particular location associated with the specific file in a time period covered by the history, determining a current location of the specific file based on the history.

2. The method of claim 1, comprising updating the specific link to be representative of the current location.

3. The method of claim 2, comprising updating the specific link upon the access of the specific link.

4. The method of claim 1, comprising maintaining a list of respective further files comprising respective links to the specific file.

5. The method of claim 4, comprising updating the respective links so as to be representative of the current location.

6. The method of claim 5, wherein the updating is carried out upon access of the specific link.

7. The method of claim 1, wherein:
the data processing system is compliant with UPnP; and
the history is maintained in a Content Directory Service.

8. Control software for use on a data processing system, the software enabling access to a specific file on a data processing system, the software being operative to maintain a history regarding migration of the specific file on the system; and to determine a current location of the specific file based on the history upon access of a specific link representative of a pointer to a particular location associated with the specific file in a time period covered by the history.

9. The control software of claim 8, operative to maintain a list of respective further files comprising respective links to the specific file.

10. The control software of claim 9, operative to update the respective links so as to be representative of the current location.

11. The control software of claim 10, operative to carry out the updating upon access of the specific link.

12. The control software of claim 8, wherein:
the data processing system is compliant with UPnP; and
the history is maintained in a Content Directory Service.

13. A data processing system enabling access to a specific file, the system being operative to maintain a history regarding migration of the specific file on the system; and to determine a current location of the specific file based on the history upon access of a specific link representative of a pointer to a particular location associated with the specific file in a time period covered by the history.
